(19) United States
(12) Patent Application Publication
(10) Pub. No.: US 2006/0123655 A1
(43) Pub. Date: Jun. 15, 2006

(54) Continuous flow grain dryer

(75) Inventor: Marcelo Norberto Valfiorani, Buenos Aires (AR)

Correspondence Address: Norris, McLaughlin & Marcus P.A., 18th Floor, 875 Third Avenue, New York, NY, 10022, US

(73) Assignee: Ingenieria Mega S.A., Buenos Aires (AR)

(21) Appl. No.: 11/291,157

(22) Filed: Dec. 1, 2005

(30) Foreign Application Priority Data
Dec. 10, 2004 (AR) P 040104617

(51) Int. Cl. F26B 7/00; F26B 3/00

(52) U.S. Cl. 34/436; 34/443

(57) ABSTRACT

A continuous flow grain dryer comprising a plurality of vertical columns for receiving and heating/drying grain, with each column having an inlet wall including side drying air inlets, and an opposite outlet wall including side exhausted air outlets, wherein the inlets and outlets are provided with diverters angularly extending towards a longitudinal axis of the column and defining a central clear region for permitting the free downward moving of the grain, with an air descending path being defined between an inlet and a downwardly adjacent outlet, and a tempering region being defined between a diverter and an associated opposite wall portion.

### BACKGROUND OF THE INVENTION

1. Field of the Invention

The present invention relates to a grain dryer and more particularly to a continuous flow grain dryer of the type employed in the drying of grains for conditioning the same for several purposes, such as for consumption, for seeds, etc. The dryer is a machine having a plurality of drying columns wherein the grain is loaded at the top of the columns and the grain under drying process moves downwardly, substantially along a zig-zag pattern to exit at a bottom of the columns, with each column provided with a plurality of side inlets for receiving heated air and a plurality of outlets for exiting exhausted air already circulated through the grain in the column, and wherein the inlets and outlets are provided with diverters to define the zig-zag pattern as well as to define tempering regions for the grain and air spaced apart paths for the heating drying air.

2. Description of the Prior Art

The grain dryers are well known in the agricultural field, these machines are generally classified on the basis of their own structures and the way the grain is handled. There are grain dryers that treat the grain in bins or batches and there are dryers wherein the grain moves along a continuous flow. Among the continuous flow dryers there is a type comprising a plurality of vertical walls made of foraminous metal sheets or plates with the walls defining vertical columns for conducting the grain from an upper loading inlet downwardly towards a bottom outlet. Spaces or plenums are defined between the foraminous columns and drying air is heated at burners and transversely circulated in the machine in order to pass through the foraminous walls in order to remove the moisture from the grain in the columns. The grain that is located against a wall, particularly the hot wall of the column tends to remain closed to such wall while moving downwardly, therefore there is a plurality of flappers provided for separating the grain from this wall and bringing the grain towards the opposite wall. This is done in order to prevent part of the grain to be over heated as compared to another part of the grain. In addition, floor diverters are provided to revert the circulating direction of the heating air, however the grain is always under the heating effect of the hot air passing through the orifices in the walls and this affects the quality of the grain that is undergoing an overheating, affecting the same by generating “fissures” and craks, for example. In addition to the foregoing the diverting floor portions promote the accumulation of grain dust that increase the fire and explosion risk in the machine. Also, the pressure into these dryers necessary to make the air circulate efficiently through the columns is very important and it demands high energy consumption.

While the above machines have been employed during many years as well as they are provided with large room for the introduction and circulation of drying air between the columns, the structure and constructions of these machines, with foraminous metal walls is very costly. In addition, the grain is compacted within the columns and the energy necessary to circulate the air as well as the contact between the air and the grain is no as efficient as desired.

There are other machines comprising a main body for containing the grain moving downwardly in the body, and including a plurality of triangular tubular diverters which are arranged in an off set pattern in order to cause the grain descend along a zig-zag pattern. These diverters are located transversely through the entire width of the main body and heated air is injected at an inlet part of the machine and circulated within each tubular diverter in order that air passes through the diverter into the mass of the grain to exit the machine at a rear part thereof. The mass of grain behaves as a very compact mass as all as the grain is within the same enclosure and retained in its downward moving by all the diverters operating as pieces of floor. In addition, there are no plenum chambers provided for the circulating heating air and therefore the room for the drying air is not enough to have an efficient drying effect.

There is another type of drying machine comprising a plurality of trays located one above the other in order to make the grain to fall from one upper tray down into a lower tray while the drying air is circulated through the several trays for contacting and drying the grain. This machine is provided with a central plenum chamber with the drying air entering the plenum, passing through the trays and exiting the machine at the periphery thereof, therefore the evaporation thermal capacity of the air is not efficiently employed because the air must pass through a compact mass of the grain and exit only at the periphery of the machine. In other words, the mass of grain is not divided into portions of low density for obtaining a more efficient and uniform contact between the hot air and the wet grain.

In connection to the grain dryers comprising a plurality of columns with air inlets at one side wall and air outlets at another opposite side wall, a plurality of flappers or diverters are located at each air inlet and air outlet to cause the grain to follow a zig-zag pattern. These diverters angularly and downwardly extend from the side walls of each column in a manner that the free ends of the diverters converges into a central longitudinal line of the column or they overlap along the longitudinal axis or central axis of the column. Thus, the descending grain follows a closed zig-zag pattern and the hot air enters by the inlets at one side of the column and exits the column at the opposite side, thus passing through the entire mass of the grain while moving downwardly.

While broadly employed in this field this machine fails to provide a real continuous flow because there is an excessive interference between the diverters and the mass of the grain. In other words, the mass of grain is subject to an enclosing hot air circulation along the entire length of the column mostly like in the dryers made of foraminous metal walls and partitions. The grain resulting from this process has multiple superficial fissures and cracks, with the low quality consequences thereof. The explanation is, the grain has been subjected to a continuous and constant heating without permitting the grain to have a stabilization, or equalization of the grain temperature as well as other parameters such as moisture, etc., in other words, the grain was not permitted to have a tempering period.

In view of the foregoing it would be desirable to have a continuous flow drying machine for removing moisture from a circulating mass of grain, and wherein the machine provides a grain having a high quality, without damages and without being affected at its agronomical capacities, and at the same time having a good drying regime and production.

### SUMMARY OF THE INVENTION

It is therefore an object of the invention to provide a continuous flow grain dryer machine of the type comprising at least one column for containing the grain that moves downwardly along a zig-zag path and a plurality of individual and spaced apart transverse air flows that pass through the mass of grain defining, between them, respective tempering regions for stabilizing and equalizing the grain conditions and parameters such as temperature and moisture.

It is still another object of the present invention to provide a continuous flow grain dryer wherein the mass of grain under drying is subjected to air passing through transverse paths whereby tempering regions are defined into the machine and into the mass of grain between the air paths, wherein the mass of grain is not affected by the air flow in order to give the mass of grain, at these regions, a period of time to stabilize and equalize its temperature and moisture, before entering, in its downward moving, into the next air flow path, whereby a gradual and uniform elimination of the moisture is obtained without affecting the quality of the grain.

It is a further object of the present invention to provide a continuous flow grain dryer comprising a plurality of vertical columns for receiving and heating/drying grain, with each column having an inlet wall including side drying air inlets, and an opposite outlet wall including side exhausted air outlets, wherein the inlets and outlets are provided with diverters angularly extending towards a longitudinal axis of the column and defining a central clear region for promoting a free downward moving of the grain, with a descending path of heating air across the mass of grain is defined between an inlet and a downward adjacent outlet, and a tempering region being defined between a diverter and an associated opposite wall portion, between adjacent air descending paths.

It is a further object of the present invention to provide a continuous flow grain dryer of the type comprising at least one vertical column for receiving the grain, wherein the grain enters at an upper inlet in the at least one column, follows a descending path within the at least one column and exits the at least one column at a bottom outlet thereof, thus defining a continuous flow, the dryer also comprising heater means for heating drying air and fun means for transversely circulating the heated air through the grain in the at least one column, with the heated air entering the at least one column through corresponding side air inlets defined in an inlet wall of the at least one column and exiting the at least one column, as exhausted air, through corresponding side air outlets in an outlet wall of the at least one column, the at least one column comprising:

an inlet diverter at each side air inlet, the inlet diverter downwardly extending from an upper edge of the side air inlet towards a longitudinal axis of the at least one column;

an outlet diverter at each side air outlet, the outlet diverter downwardly extending from an upper edge of the side air inlet towards said longitudinal axis of the at least one column;

wherein the inlet wall comprises inlet wall portions extending between adjacent side air inlets, with each inlet wall portion being opposite to an associated outlet diverter, and

wherein the outlet wall comprises outlet wall portions extending between adjacent side air outlets, with each outlet wall portion being opposite to an associated inlet diverter, and

wherein each inlet diverter and each outlet diverter extends along an angle in a manner that the geometrical projection of an inlet diverter intersects a free end region of an outlet diverter and vice versa, and wherein each inlet diverter has a free end and each outlet diverter has a free end, and the free ends of the inlets diverters being vertically aligned to define an inlet line and the free ends of the outlet diverters are vertically aligned to define an outlet line, with the inlet and outlet line being spaced apart to define a central vertical clear region in the at least one column for the free pass of the grain,

whereby an inlet diverter and a downwardly adjacent outlet diverter define an air descending circulating path, with corresponding grain tempering regions being defined between an inlet diverter and at least part of its associated opposite outlet wall portion.

It is a further object of the present invention to provide a continuous flow grain dryer of the type comprising at least one vertical column for receiving the grain, wherein the grain enters at an upper inlet in the at least one column, follows a descending path within the at least one column and exits the at least one column at a bottom outlet thereof, thus defining a continuous flow, an oscillating gate at the bottom outlet of the at least one column, for regulating the amount of grain exiting the bottom outlet, the dryer also comprising heater means for heating drying air and fun means for transversely circulating the heated air through the grain in the at least one column, with the heated air entering the at least one column through corresponding side air inlets defined in an inlet wall of the at least one column and exiting the at least one column, as exhausted air, through corresponding side air outlets in an outlet wall of the at least one column.

The above and other objects, features and advantages of this invention will be better understood when taken in connection with the accompanying drawings and description.

### BRIEF DESCRIPTION OF THE DRAWINGS

The present invention is illustrated by way of example in the following drawings wherein;

FIG. 1 shows a side elevational and partial cross-sectional view of a continuous flow grain dryer according to the present invention;

FIG. 2 shows a cross-section taken along line II-II of FIG. 1;

FIG. 3 shows a cross-sectional top plan view of the side-by-side columns and plenum chambers according to the present invention;

FIG. 4 shows a side elevational cross sectional view of a pair of columns and a plenum according to the invention;

FIG. 5 shows a side elevational cross sectional diagrammatical view of one column including the teachings according to the invention;

FIG. 6A shows a side elevational partially cross-sectional view of a lower portion of the machine of the invention;

FIG. 6B shows a detail of the gate mechanism at the bottom outlet of a column for discharging the grain;

FIG. 7 shows a perspective elevational and partially cross sectional view of a pair of columns and a plenum including the teachings of the invention;

FIG. 8 shows a perspective view of a bottom structure for mounting the assembly of columns according to the invention, and

FIG. 9 shows a detailed perspective view of a mechanism for actuating the oscillating gates at the bottom of the columns according to the invention.

### DESCRIPTION OF THE PREFERRED EMBODIMENTS

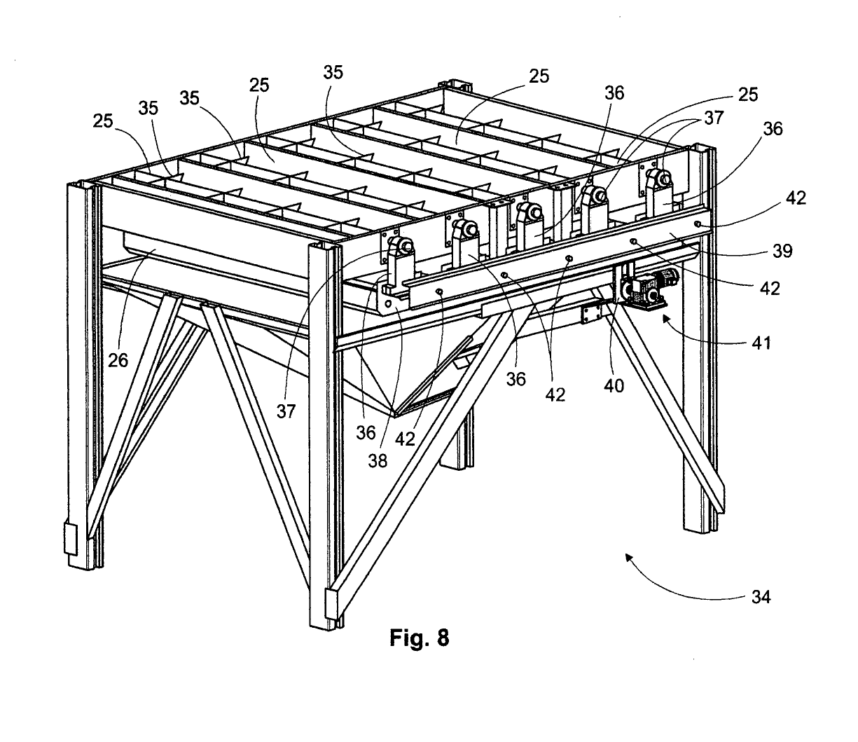

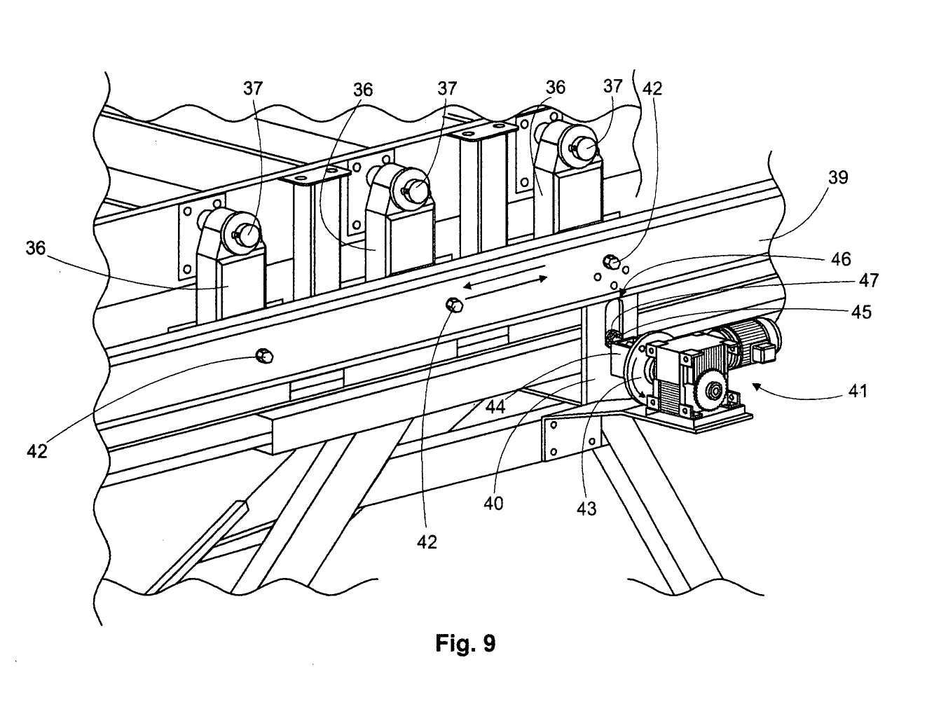

Now referring in detail to the invention, the same refers to a continuous flow grain drying machine indicated by general reference number 1, having a central body 2 for receiving and circulating the grain to be dried, a rear chamber 3 for entering hot drying air into body 2 and a leading exhausted air chamber or collector 4. Main body 2 has at an upper portion thereof a general grain inlet 5 and an adjacent downwardly located loading hopper 6 debouching into main body 2. The grain containing moisture, or wet grain, enters through inlet 5, moves downwardly through main body 2, it is dried by the hot air flowing through the mass of grain and exists the machine through a general dry grain outlet 7 at the bottom of the machine. The exiting of grain is controlled by a gate mechanism 8 better illustrated in FIGS. 6A and 6B to which reference will be made below. Air from outside is entered into chamber 3 and is heated by a plurality of burners 22 that may be operated by several fuels and located in several positions. One or more partitions 23 may be provided into chamber 3 for directing the hot air as desired. Air enters, as indicated by arrows 24, from the bottom of the machine structure, or bottom structure, moves upwardly and is heated by the burners. The bottom structure is basically conformed of support columns and frames and other mechanisms as better illustrated in FIGS. 8 and 9.

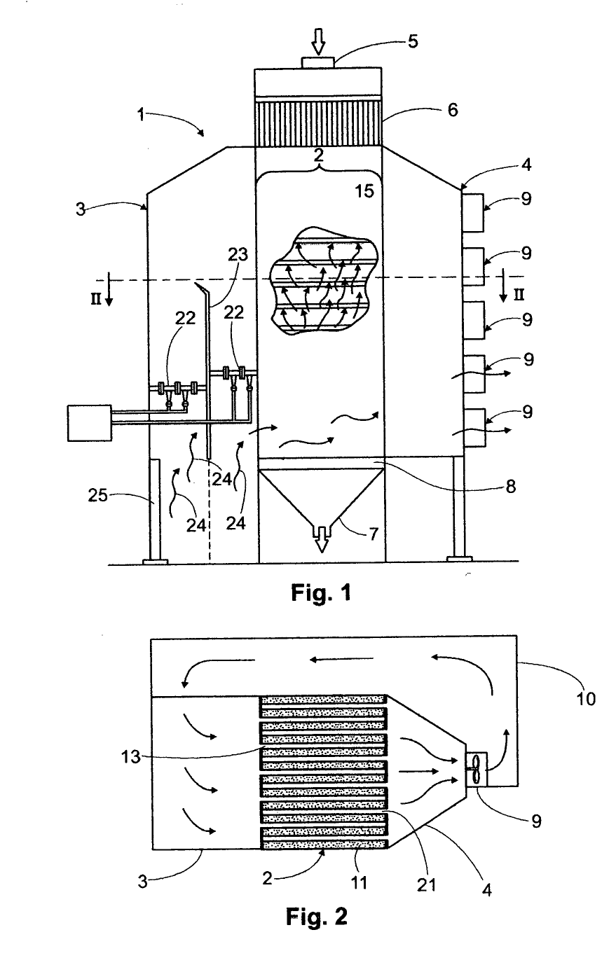

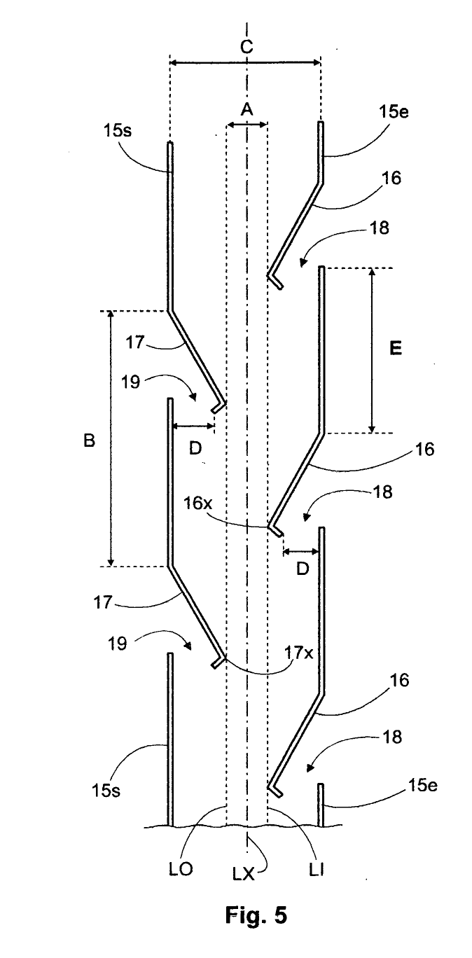

The internal arrangement of body 2 is clearly shown in FIGS. 2 to 5 and 7, with FIG. 5 showing a diagrammatic view of a column including the dimensional relationships according to the concepts of the invention. As it is shown in FIGS. 1 and 2, funs 9 are provided at the general outlets of chamber 4 for the exhausted air thus producing a depressing atmosphere or vacuum condition to bring the air from chamber 3 through central body, including the drying columns as it will be explained, and into chamber 4. Exhausted air may be re-circulated into chamber 3, as shown by the arrows, through re-circulation chamber 10, to save thermal energy. Thus, the air is blown by funs 9 at a temperature of about 35° C. to about 40° C. through chamber 10 and it is re-inserted into chamber 3 at a location before the burners thus mixing with fresh air and combining at a temperature of about 30° C. to about 33° C. This produces a saving in terms of kilograms of fuel per ton of dried grain even at temperatures of about 15° C. in the light hours and at 6° C. in the night during the drying period for maize, soy or sorghum. Of course these temperature ranges may be adjusted as desired, within the teachings of the invention, by any person skilled in the art.

Generally, the exhausted air exiting the lower parts of the dryer are with a larger content of moisture, therefore the air to be recycled is the one coming from the funs at the upper part of the machine where the grain is dryer than at the bottom of the machine. In any event, if the lower exhausted air is to be used, some filters and some additional fuel would be necessary clean the air and to evaporate the higher content of moisture.

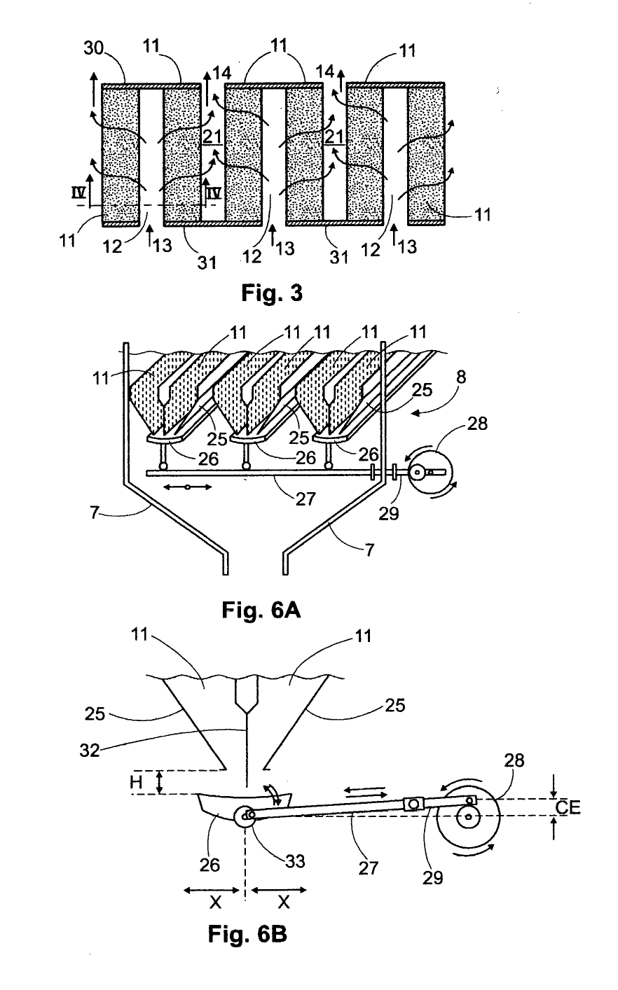

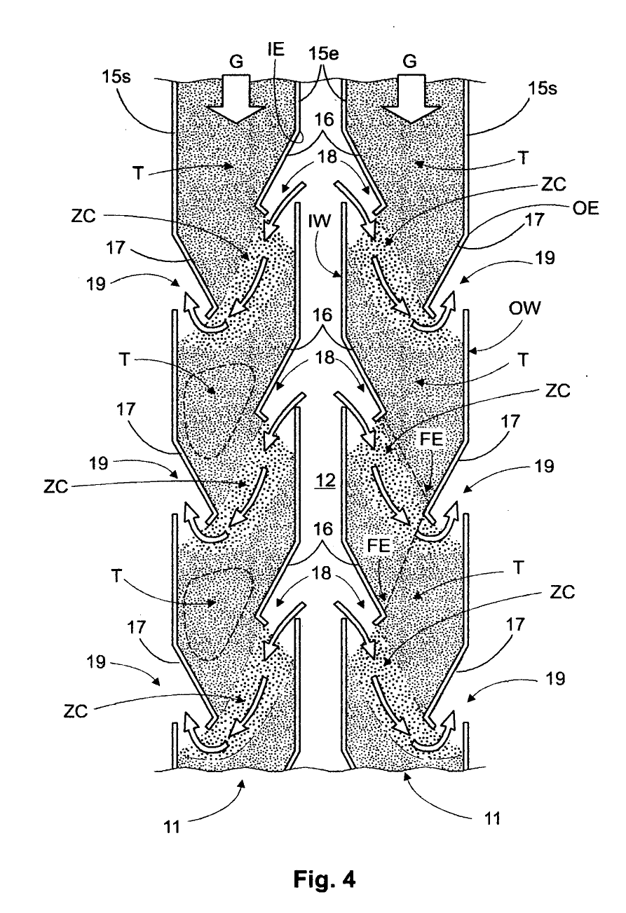

Central body 2 is comprised of a plurality of side-by-side arranged vertical columns 11 for receiving the grain, wherein the grain enters at an upper inlet in the column, as indicated by arrows G in FIG. 4, follows a descending path within the column and exits at a bottom outlet in the column, thus defining a continuous flow for the grain. As shown in FIG. 3, columns 11 are alternated with plenum chambers 13 for receiving the hot air from chamber 3, and plenum chambers 21 for exiting the exhausted air. In order to force the air across columns 11 and the mass of grain, plenums 21 are closed by partitions or walls 31 at a rear side of the columns and plenums 13 are closed at a leading side of the columns by partitions or walls 30. Thus, hot air, as indicated by the arrows, enters plenums 13 and, because of bottom wall 30, follows through column 11, passing through the mass of grain and exits by plenum 21 towards exit 14 and chamber 4. In the meantime, the grain entering from inlet 5 is continuously descending along column 11 and is exiting column 11 through outlet hopper 7.

With reference to FIG. 4 showing a cross section taken through line IV-IV of FIG. 3, two adjacent columns 11 are illustrated with a plenum chamber 12 between the columns. Hot air, indicated by white arrows, coming from plenum 12 enters each column through corresponding side air inlets 18 defined in an inlet wall, generically indicated by reference IW, and exits the column, as exhausted air, through corresponding side air outlets 19 in an opposite outlet wall, indicated by general reference OW.

Each column comprises an inlet diverter 16 at each side air inlet 18 with inlet diverter 16 downwardly extending from an upper edge IE of the side air inlet towards a longitudinal axis LX of the column. The column further comprises an outlet diverter 17 at each side air outlet 19 with the outlet diverter downwardly extending from an upper edge QE of the side air inlet towards said longitudinal axis of the column.

In addition, inlet wall IW comprises inlet wall portions 15e extending between adjacent side air inlets 18 and each inlet wall portion 15e is opposite to an associated outlet diverter 17. In like manner, outlet wall QW comprises outlet wall portions 15s extending between adjacent side air outlets 19 and each outlet wall portion 15s is opposite to an associated inlet diverter 16. Preferably, each diverter 16, 17 and its adjacent wall portion 15e, 15s comprises only one metal plate folded at a line defining said upper edge IE, OE of the side air inlet 18 and air outlet 19. Most preferably, the metal plate is a modular plate that defines one inlet wall portion and one inlet diverter when it is installed at the inlet wall of the column, and that defines one outlet wall portion and one the outlet diverter when it is installed at the outlet wall of the column. In other words, the metal plate is modular, that is made in one format and serves to conform the wall portions and diverters of both, the inlet and the outlet side.

Also according to the invention, the inlet and outlet diverters extends downwardly and angularly, forming an angle with the side wall, in a manner that the geometrical projection of an inlet diverter intersects, shown in phantom line in FIG. 4, a free end region, indicated by reference FE, of an outlet diverter 17, and vice versa. That is, the projection of a diverter 17 intersects a free end region of a downward diverter 16. In addition, each inlet diverter 16 has a free end 16x and each outlet diverter 17 has a free end 17x, and the free ends of the inlets diverters are vertically aligned to define an inlet line LI and the free ends of the outlet diverters are vertically aligned to define an outlet line LO. Inlet LI and outlet LO lines are spaced apart to define a central vertical clear region, having a width A, see FIG. 5, for permitting a fluent and free downward moving of the grain.

According to the above disclosure, an inlet diverter 16 and a downwardly adjacent outlet diverter 17 define, together, an air crossing and descending circulating path ZC, and corresponding grain tempering regions T, are defined between an inlet diverter 16 and at least part of its associated opposite outlet wall portion 15s. For clarity purposes, only two tempering regions T, enclosed in dotted lines, are shown at the left column in FIG. 4.

As it is clear from the above disclosure, fresh air coming from outside the machine passes through the burners, is heated and then, as hot air, enters chamber 3 which is in fluid communication with plenum chambers 13 between columns 11. Thus, the hot air enters inlets 16, passes along descending path ZC across the downwardly moving mass of grain, indicated by big arrows G in FIG. 4, and exits the column through outlets 19 towards plenum chambers 21 and general exits 14. The air circulates in this manner as a result of the vacuum or suction generated by funs or blowers 9. The effect of the air descending paths ZC and the tempering regions will be better explained below.

In its downward movement along column 11, the mass of grain passes through successive and alternating air paths ZC and tempering regions T. When passing through a drying air path ZC the grain is heated and part of the moisture is evaporated. If, as in the conventional machines, the grain downward flow is too high, the grain passing through a zone ZC will follow to the next zone ZC too quickly. This would result in a quick and overheating effect on the grain without permitting the moisture located at the most inner parts of the grain to be removed. If, on the contrary, the grain downward movement is too low, the grain will be extremely exposed to the heating air with the same above overheating results and inefficient moisture removal. According to the invention, the grain passes through region ZC during a time enough to partially and uniformly heating the grain. Then, the heated grain, with the heat still not uniformly distributed across the mass of the grain, passes to the tempering region T. In this region, the grain movement is slower in order that the mass of grain has time to uniform and equalize the temperature all across the mass of grain. Thus, before entering the next heating zone ZC, the grain will have a uniform status in terms of temperature, moisture and eventually, other parameters. The final result is a gradual and uniform heating and desired dehydration of the entire mass of grain. It must be remarked that, due to the particularities of the invention, namely the design and arrangement of the diverters, air inlets 16 and outlets 17, as well as the side walls 15e, 15s, the air flow in regions ZC follows a downward path and it does not take any rising path that would pass across tempering regions T with negative consequences for the grain quality as it occurs in the machines of the prior art.

To better accomplish with the purposes of the invention, the components of the inventive machine are designed according to preferred dimensions and relationships as it is illustrated in the diagrammatic view of FIG. 5. Column 11 has a width indicated by reference “C” and said central vertical clear region has a width indicated, as mentioned above, with reference “A”, and width A is preferably equal to a value between about 0.28 C to about 0.38 C and more preferably, width A is 0.33 C. Furthermore, a distance “D” is defined between the free end of an inlet diverter 16 and the downwardly adjacent inlet wall portion 15e, as well as between the free end of an outlet diverter 17 and a downwardly adjacent outlet wall portion 15s. According to the invention distance D is preferably between about 0.28 C to about 0.38 C, and more preferably distance D is 0.33 C. In addition, distance “B” is defined between the upper edges IE of two adjacent side air inlets 16, and between the upper edges OE of adjacent side air outlets 17, with distance B being between about 1.60 C to about 2.00 C. Furthermore, each wall inlet 15e and outlet 15s portion has a length E of between about 0.92 C to about 1.16 C.

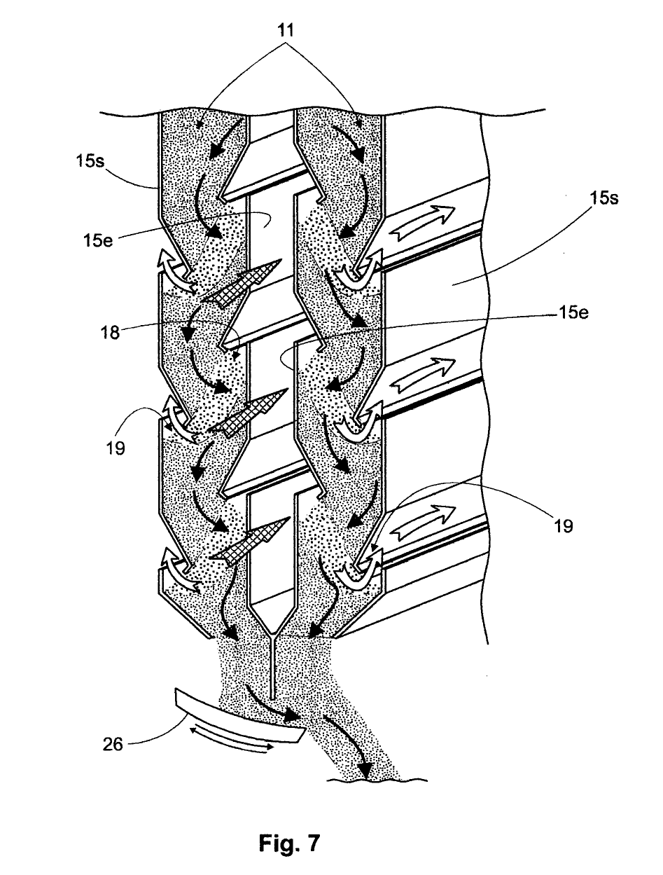

According to another aspect of the invention, FIGS. 6A and 6B show a bottom part of columns 11 wherein a gate mechanism 8 is provided to regulate and adjust the dispensing of dry grain. Mechanism 8 comprises a plurality of oscillating gates, indicated with reference 26 in FIGS. 6A, 6B, 7 and 8, each one at the bottom outlet of each column. Gate 26 moves according to an oscillating pattern, as indicated by the arrows in FIG. 7, to facilitate and regulate the amount of grain and the low thereof exiting the bottom outlet. According to an embodiment of the invention, gate 26 oscillates in a pivoting axis 33 which is eccentrically connected to an actuating arm 27 in turn connected to a connecting rod 29 which in turn is connected to a crank mechanism in a rotary disc 29 which is driven by motor means not illustrated. The vertical position “H” as well as the oscillating extent or amplitude “X-X” of gate 26 may be adjusted and regulated according to the type of grain and drying capacity of the dryer. To vary the oscillating amplitude “X-X” in order to increase the unloading capacity, distance “CE” between the center of disc 28 and the point wherein rod 29 is connected to the disc must be enlarged. The vertical position of gate 26 along “H” can also be adjusted to operate in combination with the oscillating amplitude for regulating exiting, however the regulation of both parameters must comply with some requisites because the movement of gate 26 would not be symmetric as to the centre of columns 11, particularly relative to a central fin 32 provided to promote a continuous discharging flow. It, due to these regulation of vertical position and amplitude the movement symmetry is altered, as occurring in the machines of the prior art, the amount of grain exiting one column will be different from the amount exiting the adjacent column. This would increase the damages by overheating in the column discharging the grain more slowly and this column will run a risk of fire. To solve this problem the length of connecting rod 29 should be modified with each adjustment of the above mentioned parameters which would render this operation costly, time consuming and cumbersome.

According to the invention, the vertical position “H” and the oscillation amplitude “X-X” may be adjusted with the gates conserving their symmetric movement relative to columns 11 and without the need of replacing or changing components of the crank mechanism or driving means. As it is illustrated in FIGS. 8 and 9, a bottom structure, indicated by general reference 34 in FIG. 8, is provided to support the entire body 2 with all the columns 11 therein and structure 3 is provided with the means, including all the necessary mechanism to unload or permitting the fluent and continuous dispensing of dry grain form the drying columns. Structure 34 includes a plurality of bottom column hoppers 25 for receiving the bottom ends of columns 11 therein. Body 2 with the columns therein is installed onto structure 34 in a manner that the bottom exits of a pair of adjacent columns are received in a corresponding hopper 25. Hoppers 25 include separating partitions 35 for better distributing the grain and immediately below each hopper an oscillating gate 26 is provided as schematically shown in FIGS. 6A and 6B. Each gate 26 is connected to a support plate 38 which in turn is adjustably connected to an oscillating support 36, thus forming a hanging regulating device. Support 36 is suspended or pivotally connected to a pivot point or axis such as a pivot shaft 37. The vertical position of gates 26 may be adjusted to vary the distance between the gate and the corresponding hopper 25 by moving plate 38 up and down along oscillating support 36 and fixing plate 38 in the desired position. For this purpose plates 38 are provided with a plurality of regulating orifices or sliders.

According to the embodiment of FIGS. 8 and 9, an actuating arm 39 is connected to all oscillating supports 36 by pivot connections 42 and includes a connection and adjusting plate 40 having a regulating groove 46 therein for connecting to driving means such as an electrical motor 41. Motor 41 has a rotary plate 43 connected to an output shaft, not illustrated, of the motor. Rotary plate 43 includes a support 44 including a pin 45 with a bearing 47 at the end thereof and housed into groove 46 of plate 40 of arm 39, thus forming a crank mechanism. Pin 45 is mounted in support 44 in a manner that the radial position of pin 45 may be varied in order to vary the eccentricity of pin 45 relative to the output shaft of motor 41. Due to this eccentricity, when the motor is on and disc 43 is rotating, pin 45 will actuate arm 39 through groove 46, namely moving up and down into groove 46 but actuating adjusting plate 40 and arm 39 back and fore as indicated by the arrows in the arm.

To modify the oscillation amplitude “X-X” the eccentricity of pin 45 may be changed by moving and fixing it in a desired radial position in support 44. If, in addition, the vertical position of gates 26 must be varied, it is not necessary other modification than moving support 36 and plate 38 without the need of altering other parameters and the mechanism will operate in a manner that gates 26 will oscillate in a complete symmetrical pattern relative to the bottom outlets of columns 11. Distinct from this, as commented above, if a connecting rod is employed, when the eccentricity is modified with the connecting rod being the same, i.e. having the same length, the distance between connection point 33 and the eccentric pin in plate 28 is kept the same, therefore point 33 is moved towards plate 28 and gates 26 result positioned in a non symmetric position relative to columns 11.

As it is reflected from the above description, the inventive machine provides a progressive and gradual heating with alternating heating zones, at the hot air paths, and tempering zones, in a manner that the grain results with a dry status with a proper residual moisture index as well as with a superior quality, without superficial fissures. This is possible because of the particular arrangement, location and design of the diverters as well as the dimensional ratios of the several column parts with the wall portions and the diverters defining the tempering regions wherein the grain remains a period of time enough to stabilize the parameters thereof.

During the downward movement of the grain along the drying column several particularities may be observed:

the zig-zag pattern is less abrupt as compared to the dryers of the prior art;

the length and inclination of the diverters define a central longitudinal region that is clear for the free pass of the mass of grain without interferences;

the arrangement of the diverters and the length of the wall portions facing the diverters define the above disclosed tempering regions, and

the circulation of hot air is through defined paths that have descending patterns from an upper inlet to a lower outlet as well as the air paths are spaced apart from each other to alternate with the tempering regions.

In view of the foregoing the grain is dried along successive heating steps and tempering steps, in an alternating sequence, whereby the grain is loosing moisture in an uniform, homogeneous and regulated manner. This results in a grain having an optimum quality and a correct residual moisture content. In addition, the columns generates a pressure and depressing zones are defined at each side of the column and the air enters the mass of grain an a low range, therefore the contra-pressure is low, of about 15 to 20 mmH2O, therefore a large volume of air with low electrical energy consumption is obtained. The flow rates are larger as compared to machines of the prior art and the drying columns do not require partitions or floor dividers therefore the cleaning and service of the inventive machine is easier as well as the fire risk is minimized. The amount of circulating air per ton of grain is large as compared to, for example, the circular columns dryers which have a small exit area as well as the air speed is so high that the grain expelled out of the dryer what is a very important inconvenience and puts limits the operation of the machine. The high air rate of the inventive machine is achieved by the special design of several side-by-side columns and the plurality of air inlets and outlets, for example, there may be 30 inlets/outlets in a 12 m length column, therefore, with 10 columns a number of 300 inlets/outlets is provided what guarantees a much more large exiting area as well as low air circulation rates or velocities.

The modular design of the inventive dryer makes possible to adapt it to several needs by varying the high and width of the entire assembly, thus obtaining desired grain handling volumes and drying capacities what is not possible with circular column dryers, for example. Because the plenum chambers are closed at one end the air flow is very concentrated to pass through the mass of grain in the corresponding columns and since all the outlets of the columns debouch into an exhausted air collector of the machine a plurality of cyclone separators may be arranged at the external outlets of the machine for collecting dust from the grain, thus preventing the environment from being contaminated and polluted as it occurs with conventional dryers.

It has been clear that the particular design of the several components of the inventive machine provides several structural and functional improvements, an optimum quality in the drying process as well as in the dried grain, a lower fuel and electrical energy consumption, an efficient pollution control and an optimum thermal and volumetric efficiency and yields.

While preferred embodiments of the present invention have been illustrated and described, it will be obvious to those skilled in the art that various changes and modifications may be made therein without departing from the scope of the invention as defined in the appended claims.

We claim:

1. A continuous flow grain dryer of the type comprising at least one vertical column for receiving the grain, wherein the grain enters at an upper inlet in the at least one column, follows a descending path within the at least one column and exits the at least one column at a bottom outlet thereof, thus defining a continuous flow for the grain, the dryer also comprising heater means for heating drying air and fun means for transversely circulating the heated air through the grain in the at least one column, with the heated air entering the at least one column through corresponding side air inlets defined in an inlet wall of the at least one column and exiting the at least one column, as exhausted air, through corresponding side air outlets in an outlet wall of the at least one column, the at least one column comprising:
an inlet diverter at each side air inlet, the inlet diverter downwardly extending from an upper edge of the side air inlet towards a longitudinal axis of the at least one column;
an outlet diverter at each side air outlet, the outlet diverter downwardly extending from an upper edge of the side air inlet towards said longitudinal axis of the at least one column;
wherein the inlet wall comprises inlet wall portions extending between adjacent side air inlets, with each inlet wall portion being opposite to an associated outlet diverter, and
wherein the outlet wall comprises outlet wall portions extending between adjacent side air outlets, with each outlet wall portion being opposite to an associated inlet diverter, and
wherein each inlet diverter has a free end and each outlet diverter has a free end, and the free ends of the inlets diverters being vertically aligned to define an inlet line and the free ends of the outlet diverters are vertically aligned to define an outlet line, with the inlet and outlet line being spaced apart to define a central vertical clear region in the at least one column for the free pass of the grain, and
wherein an inlet diverter and a downwardly adjacent outlet diverter define an air descending circulating path, with corresponding grain tempering regions being defined between an inlet diverter and at least part of its associated opposite outlet wall portion.

2. The grain dryer of claim 1, wherein each inlet diverter and each outlet diverter extends along an angle in a manner that the geometrical projection of an inlet diverter intersects a free end region of an outlet diverter and vice versa.

3. The grain dryer of claim 2, wherein each diverter and its adjacent wall portion comprises only one metal plate folded at a line defining said upper edge of the side air inlet and air outlet.

4. The grain dryer of claim 3, wherein the metal plate is a modular plate that defines one inlet wall portion and one inlet diverter when it is installed at the inlet wall of the at least one column, and that defines one outlet wall portion and one the outlet diverter when it is installed at the outlet wall of the at least one column.

5. The grain dryer of claim 1, wherein the at least one column comprise a plurality of side-by-side columns and a plenum chamber is defined between two adjacent columns.

6. The grain dryer of claim 1, wherein the at least one column has a width C and said central vertical clear region has a width A, with width A being between about 0.28 C to about 0.38 C.

7. The grain dryer of claim 6, wherein width A is 0.33 C.

8. The grain dryer of claim 6, wherein a distance D is defined between the free end of an inlet diverter and the downwardly adjacent inlet wall portion, and between the free end of an outlet diverter and a downwardly adjacent outlet wall portion, with distance D being between about 0.28 C to about 0.38 C.

9. The grain dryer of claim 8, wherein distance D is 0.33 C.

10. The grain dryer of claim 6, wherein a distance B is defined between the upper edges of two adjacent side air inlets, and between the upper edges of adjacent side air outlets, with distance B being between about 1.60 C to about 2.00 C.

11. The grain dryer of claim 6, wherein each wall inlet and outlet portion has a length E of between about 0.92 C to about 1.16 C.

12. The grain dryer of claim 1, further comprising an oscillating gate at the bottom outlet of the at least one column, the gate regulating the amount of grain exiting the bottom outlet.

13. The grain dryer of claim 12, wherein the oscillating gate is suspended from a pivot shaft at a bottom structure of the grain dryer and it is connected to an actuating arm which in turn is connected to motor means.

14. The grain dryer of claim 13, wherein the actuating arm is connected to the motor means through a crank mechanism.

15. The grain dryer of claim 13, wherein a hanging regulating device is provided to suspend the oscillating gate from the pivot shaft, for varying the distance between the gate and the bottom outlet of the at least one column.

16. The grain dryer of claim 13, wherein the oscillating gate has vertical and horizontal adjustable positions.

17. The grain dryer of claim 14, wherein the actuating arm includes an adjusting plate connected to a pin of the crank mechanism.

18. The grain dryer of claim 17, wherein the pin is radially adjustably mounted in a support fixed to a rotary disc of the crank mechanism.

19. The grain dryer of claim 1, wherein the at least one column comprise a plurality of side-by-side columns and an oscillating gate is provided at the bottom outlet of each column, the gate regulating the amount of grain exiting the bottom outlet of each column.

20. The grain dryer of claim 19, wherein the oscillating gate is suspended from a pivot shaft at a bottom structure of the grain dryer and it is connected to an actuating arm which in turn is connected to motor means.

21. The grain dryer of claim 20, wherein the actuating arm is connected to the motor means through a crank mechanism.
